(19) United States
(12) Patent Application Publication
(10) Pub. No.: US 2012/0167511 A1
(43) Pub. Date: Jul. 5, 2012

(54) Pet door

(76) Inventor: James Laudenklos, Newman Grove, NE (US)

(21) Appl. No.: 12/930,144

(22) Filed: Dec. 29, 2010

(51) Int. Cl. E06B 3/34

(52) U.S. Cl. 52/386

(57) ABSTRACT

The pet door of this invention is mounted at the outer side of an opening formed in a door or wall. The pet door includes an upper edge, a lower edge, a first side edge and a second side edge. The second side edge of the pet door includes a laterally and outwardly extending portion. The first side edge of the pet door is pivotally secured to the door or wall by a pair of vertically disposed and vertically spaced spring-loaded hinges which yieldably maintain the pet door in a closed position.

### BACKGROUND OF THE INVENTION

1. Field of the Invention

This invention relates to a pet door and more particularly to a pet door which is positioned at the outside of an opening formed in a door or wall. More particularly, this invention relates to a pet door which includes a laterally and outwardly extending door portion at one side thereof so that the pet, when seeking entry into the building, may place its nose behind the laterally and outwardly extending door portion and push on the same to open the pet door.

2. Description of the Related Art

Many types of pet doors have been previously provided. Most pet doors fit in an opening formed in a door or wall with the upper end of the pet door being hingedly secured to a door or wall about a horizontal axis. The pet may push the pet door from either side thereof to open the door. In many cases, the pet doors are maintained in their closed position by magnets or the like. A problem with the conventional pet doors of the type described is that the magnets do not have sufficient strength to maintain the pet door in its closed position if the pet door is subjected to a strong wind. Further, there is a problem associated with the weather sealing of the pet door to the door or wall adjacent the opening formed therein.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A pet door is disclosed for installation on the outside surface of a door or wall having an opening formed therein with the opening having an upper edge, a lower edge, a first side edge and a second side edge. First and second vertically spaced and vertically disposed spring-loaded hinges are secured to the outside surface of the door or wall adjacent the first side edge of the opening formed therein. A generally flat door member having an upper edge, a lower edge, a first side edge and a second side edge is provided. The door member has a width and height sufficient to cover the outer side of the opening. The first side edge of the flat door member is secured to the spring-loaded hinges. The door member is movable from a normally closed position to an open position. The second side edge of the door member includes an outwardly and laterally extending door portion associated therewith to enable a pet to place the pet's nose between the door portion and the outside surface of the door or wall so that the pet may move the door member from its closed position to its open position when the pet is outside of the opening and wishes to move inwardly through the opening. The pet door is also movable from its closed position to its open position by a pet that is inwardly of the opening by pushing against the door member to open the same.

The spring-loaded hinges are adjustable to increase or decrease the resistance to the opening of the door member. Preferably, the pet door is comprised of a clear plastic material. A weather seal is provided on the inside surface of the door member or on the outside surface of the door or wall.

It is therefore a principal object of the invention to provide an improved pet door.

A further object of the invention is to provide a pet door which will not open inwardly when subjected to strong winds or the like.

A further object of the invention is to provide a pet door for a door or wall which includes a laterally and outwardly extending portion at one side thereof so that the pet is able to place its nose between the laterally and outwardly extending portion and the outside surface of the door or wall to move the door member to its open position when the pet wishes to open the pet door from the outside side thereof.

A further object of the invention is to provide a novel weather seal at the inside surface of the pet door or on the outside surface of the door or window.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the pet door of the invention mounted on a door or window;

FIG. 2 is an exploded perspective view of the invention;

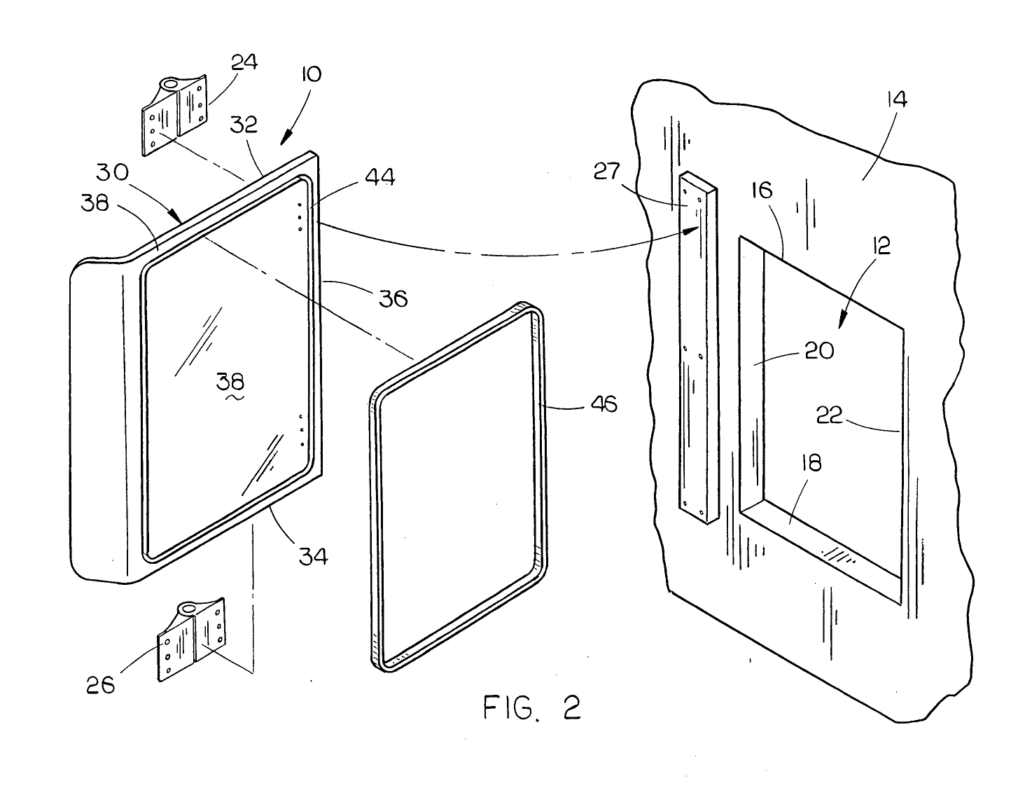

FIG. 3 is a sectional view of the invention mounted on a door or window; and

FIG. 4 is an exploded perspective view of the invention wherein the weather seal is embedded in the outside surface of the door or wall.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers to the pet door of this invention which is positioned at the outer side of an opening 12 formed in a door or wall 14. Opening 12 includes an upper edge 16, a lower edge 18, a first side edge 20 and a second side edge 22. Opening 12 may be square, rectangular or oval in shape. The outer hinge portion of conventional spring-loaded hinges 24 and 26 are secured to a strip member 27, which is secured to the door or wall 14, at side edge 20 by screws or bolts 28 at the outside surface thereof.

Pet door 10 includes a pet door member 30 which normally will have the same shape as the opening 12. However, pet door member 30 could be square or rectangular even if the opening 12 is square, rectangular or oval. In any event, pet door member 30 must have a width greater than the width of the opening 12 and must have a height greater than the height of the opening 12.

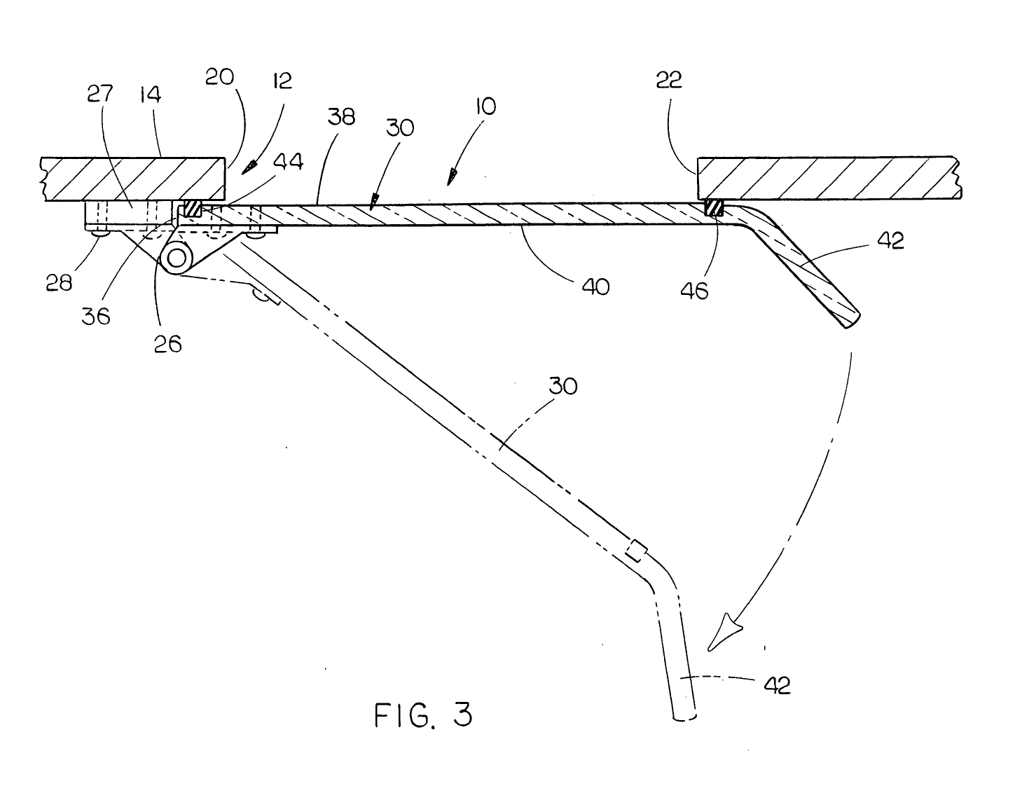

Pet door member 30 will be described as having an upper edge 32, a lower edge 34, and a first side edge 36, an inner side 38 and an outer side 40. A laterally and outwardly extending pet door portion 42 is provided at the side of door member 30 which is opposite to side edge 36. As seen in FIG. 3, the door portion 42 is positioned laterally of the second side edge 22 of opening 12.

The inner side 38 of door member 30 has a recessed channel 44 formed therein, the dimensions of which are greater than the dimensions of the opening 12. A strip of weather strip material 46 is positioned in channel 44 and held therein by a suitable glue or adhesive. As seen in FIG. 3, weather strip material 46 protrudes from the inner side of pet door 30 so as to sealably engage the outside surface of the door or wall 14 around the opening 12 when the pet door 30 is in its closed position.

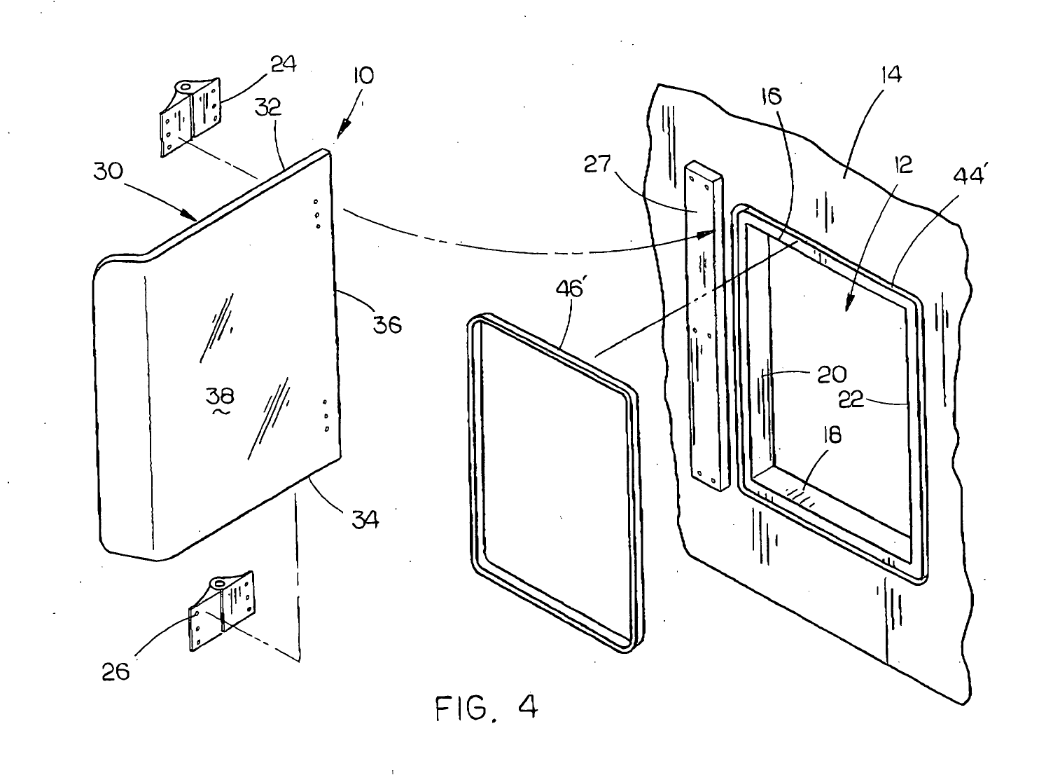

In the embodiment of FIG. 4, the outside surface of the door or wall 14 has a recessed channel 44′ formed therein which extends around the opening 12. A strip of weather strip material 46′ is positioned in channel 44′ and held therein by a suitable glue or adhesive. The weather strip material 46′ protrudes outwardly from the outside surface of the door or wall 14 to sealably engage the inside surface of the pet door 30 when the pet door 30 is in its closed position.

The hinges 24 and 26 are secured to the pet door 30 at the first side edge 36 thereof by screws or bolts 47. The hinges 24 and 26 are spring loaded and yieldably maintain the pet door in its closed position. Preferably, the springs of the hinges 24 and 26 are adjustable to vary the resistance to the opening of the door member 30.

Preferably, the pet door member 30 is comprised of a plastic material or Lexan® but may be comprised of other materials if so desired.

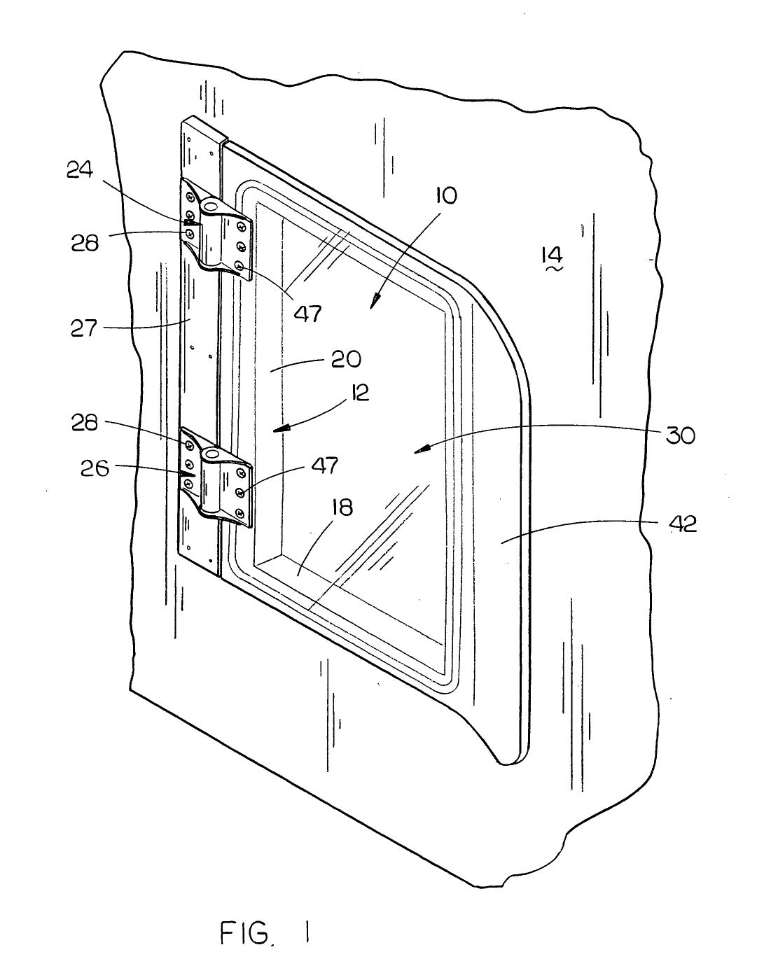

The pet door of this invention is installed as will now be described. An opening 12 is formed in the door or wall 14 and is preferably of the rectangular shape illustrated in FIG. 1. A strip of material 27 is secured to the door or wall 14 laterally of the opening 20 as illustrated in FIG. 1. The inner sides of the hinges 24 and 26 will be secured to the door member 30 by the screws 47 with the outer end of the hinges 24 and 26 being secured to the strip 27 by screws or bolts 28. As stated, the dimensions of the door member 30 are such that it will completely cover the opening 12 as illustrated in the drawings. The hinges 24 and 26 yieldably and adjustably maintain the door member 30 in the closed position of FIGS. 1 and 3. When the door member 30 is in the closed position of FIG. 3, the weather strip material 46 engages the outer surface of the door or wall 14 around the opening 12 to weather seal the door member 30 with respect to the opening 12. In the embodiment of FIG. 4, the weather strip material 46′ engages the inside surface of the door member 30 around the opening 12 to weather seal the door member 30 with respect to the opening 12.

When a pet is inside the building in which the door or window is installed, the pet may pass through the opening 12 by pushing outwardly against the door member 30 which will cause the door member 30 to pivotally move against the resistance in the hinges 24 and 26 through the dotted line position and greater than that as illustrated in FIG. 3. The pet may then exit the interior of the building through the opening 12.

If the pet is outside of the building and wishes to gain access to the interior of the building by means of the opening 12, the pet will place its nose between the outer surface of the door or wall and the lower portion 42 and push outwardly on the door portion 42 which will cause the door member 30 to pivotally move or swing from the position of solid lines in FIG. 3 to the open line position of FIG. 3 so that the pet may pass through the opening 12.

The fact that the door member is positioned outwardly of the opening 12 prevents the door from moving inwardly from the closed position of FIG. 3 by a strong wind or the like.

Thus it can be seen that a novel pet door has been provided which accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A pet door for installation on the outside surface of a door or wall having an opening formed therein with the opening having an upper edge, a lower edge, a first side edge and a second side edge, comprising:
at least one vertically disposed spring-loaded hinge secured to the outside surface of the door or wall adjacent said first side edge of the opening formed therein;
a generally flat door member having an inside surface, an outside surface, an upper edge, a lower edge, a first side edge and a second side edge;
said door member having a sufficient height and width to cover the openings;
said first side edge of said door member being secured to said spring-loaded hinge;
said door member being movable from a normally closed position to an outwardly extending open position;
said second side edge of said door member having a laterally and outwardly extending portion associated therewith to enable a pet to place the pet's nose inwardly thereof so that the pet may move the door from its closed position to its open position when the pet is outside of the opening and wishes to move inwardly through the opening;
said pet door also being movable from its said closed position to its said open position by a pet that is inwardly of the opening, by pushing outwardly against the door member to open the same.

2. The pet door of claim 1 wherein said laterally and outwardly extending portion of said door member extends laterally and outwardly from the door opening when said door member is in its closed position.

3. The pet door of claim 1 wherein a pair of vertically disposed spring-loaded hinges is secured to the outside surface of the door or wall adjacent said first side edge of the opening formed therein.

4. The pet door of claim 3 wherein said spring-loaded hinges are adjustable to increase or decrease the resistance to the opening of the door member.

5. The pet door of claim 1 wherein said inside surface of said door member has a channel formed therein and wherein a weather strip is positioned in said channel which sealably engages the outside surface of the door or wall around the opening formed therein when said door member is in its said closed position.

6. The pet door of claim 1 wherein said door member is comprised of a plastic material.

7. The pet door of claim 1 wherein said door member is comprised of Lexan®.

8. The pet door of claim 1 wherein the outside surface of the door or wall has a channel formed therein and wherein a weather strip is positioned in said channel which sealably engages the inside surface of said door member around the opening formed in the door or wall when said door member is in its said closed position.
